(19) United States
(12) Patent Application Publication
(10) Pub. No.: US 2017/0370288 A1
(43) Pub. Date: Dec. 28, 2017

(54) OIL DISTRIBUTION SYSTEM AND TURBOMACHINE WITH AN OIL DISTRIBUTION SYSTEM

(71) Applicant: Rolls-Royce Deutschland Ltd & Co KG, Blankenfelde-Mahlow (DE)

(72) Inventor: Stephan UHKOETTER, Blankenfelde-Mahlow (DE)

(21) Appl. No.: 15/603,944

(22) Filed: May 24, 2017

(30) Foreign Application Priority Data
Jun. 28, 2016 (DE) 10 2016 111 855.9

(51) Int. Cl. F02C 7/06

(52) U.S. Cl. CPC F02C 7/06; F05D 2260/40311; F05D 2220/323; F05D 2240/55

(57) ABSTRACT

An oil distribution system for a casing having at least one component to be supplied with oil in the interior of the casing, where the oil can be fed into the interior of the casing by at least one distribution device and where during operation the oil is conveyed by a centrifugal force to the at least one component, including at least one seal, in particular a contact seal or labyrinth seal for sealing off the casing from the environment, with the at least one seal being designed and/or arranged in the oil distribution system such that during operation it releases, due to the centrifugal force, at least one sealing gap for pressure equalization to provide a connection between the interior of the casing and the environment. Furthermore, the invention relates to an aircraft engine.

This application claims priority to German Patent Application DE102016111855.9 filed Jun. 28, 2016, the entirety of which is incorporated by reference herein.

This invention relates to an oil distribution system in accordance with the features of Claim 1 and to a turbomachine having an oil distribution system in accordance with the features of Claim 12.

In turbomachines, in particular aircraft engines, oil is used for example to lubricate components, to cool components, to seal off rotating components and/or to prevent corrosion in or on gearboxes and bearings. Distribution devices distribute the oil to the respective consumers, for example gears, splines or rolling bearings. For planetary gearboxes, an oil distribution system is known for example from EP 1 767 814 B1 or the article by Krug et al., “Experimental investigation into the efficiency of an aero engine oil jet supply system”, in Proceedings of the ASME Turbo Expo 2014, Jun. 16-20, 2014, Düsseldorf.

The object is to provide efficient and dependable oil distribution systems.

Solution is provided by an oil distribution system in accordance with the features of Claim 1.

To do so, an oil distribution system for a casing having at least one component to be supplied with oil is used in the interior of the casing, where the oil can be fed into the interior of the casing by at least one distribution device and where during operation the oil is conveyed by a centrifugal force to the at least one component to be supplied. At least one seal, in particular a contact seal or labyrinth seal, is used to seal off the casing from the environment, with the at least one seal being designed and/or arranged in the oil distribution system such that during operation it releases, due to the centrifugal force, at least one sealing gap for pressure equalization to provide a connection between the interior of the casing and the environment.

In one embodiment, the at least one component to be supplied with oil is a bearing, a plain bearing, a rolling bearing, a gear and/or an oil seal.

In a further embodiment, the at least one seal is arranged on a non-rotating component and the sealing gap is formed towards to a rotating component during operation. Alternatively, the at least one seal is arranged on a rotating component and the sealing gap is formed towards to a non-rotating component during operation. Depending on the geometrical arrangement, the seal can in this way release the sealing gap due to the centrifugal force effective during operation.

In one embodiment, the distribution device for oil is surrounded radially on the inside and/or the outside by a circumferentially arranged surrounding element forming the sealing gap in each case in interaction with the at least one seal. The surrounding element can, for example, be used as an oil guide element of the oil duct.

In a further embodiment, the at least one distribution device for the oil has a nozzle or an opening, where the distribution device sprays oil in particular in the axial, in the radial, in an inclined direction between the axial and radial directions or in the tangential direction. In the case of spraying in the tangential direction, the oil can already be sprayed at an appropriate speed onto a rotating component.

Furthermore, in another embodiment the oil is conveyed via a collecting device, in particular a groove and/or a distribution device, to the at least one component to be supplied with oil. This allows the oil to be supplied also to areas (e.g. areas that are offset in the axial direction) that cannot be reached at all or only with difficulty using solely the centrifugal force, which is only effective radially.

In a further embodiment, the casing is a gearbox casing, in particular for an epicyclic gearbox, a planetary gearbox, a power gearbox for a turbofan engine or a bearing casing. An oil supply inside these casings is particularly relevant.

In a further embodiment, the at least one seal is designed as a radial seal or radial shaft seal. These types of seals can be produced inexpensively.

In one embodiment, the oil distribution system can also have a self-adjusting oil supply for at least one component to be supplied with oil. In operation, a self-adjusting oil supply can be achieved by the opening of the sealing gap, while sealing off from the environment is assured due to the at least one seal in the stationary state.

Solution is provided by an aircraft engine, in particular a turbofan engine, in accordance with the features of Claim 12.

The invention is explained in connection with the exemplary embodiments shown in the figures. Here,

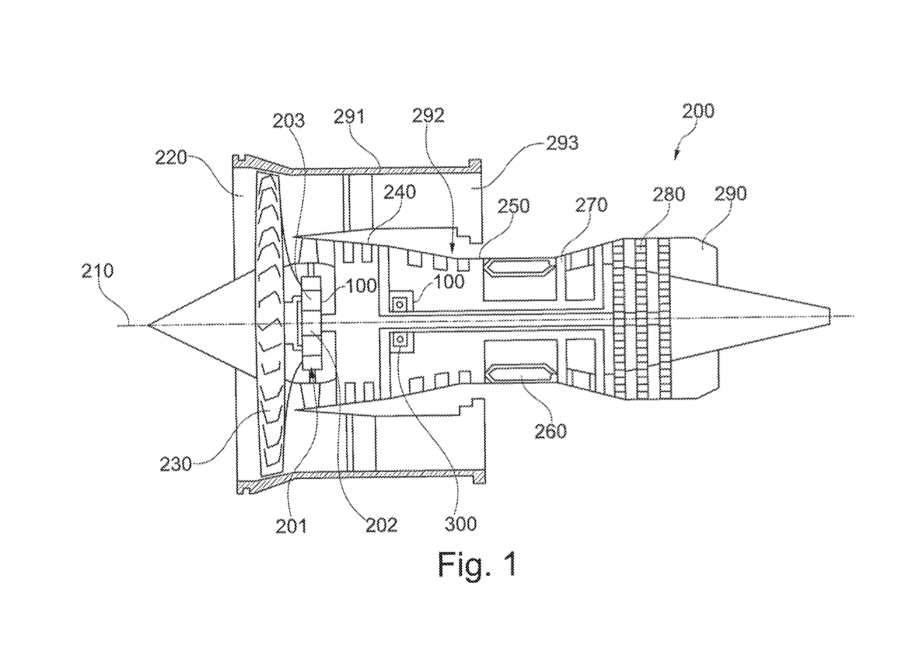

FIG. 1 shows a schematic representation of an aircraft engine in turbofan design, having a planetary gearbox as a power gearbox,

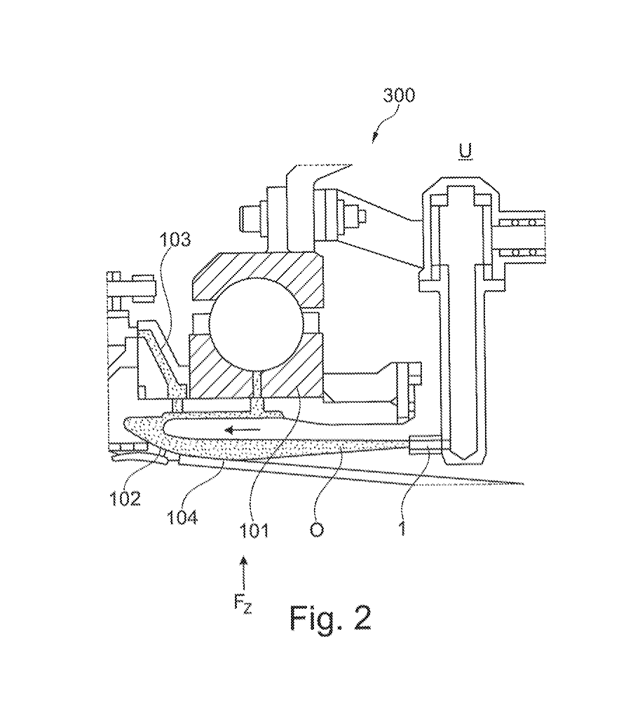

FIG. 2 shows a schematic view of an oil distribution system known from the state of the art,

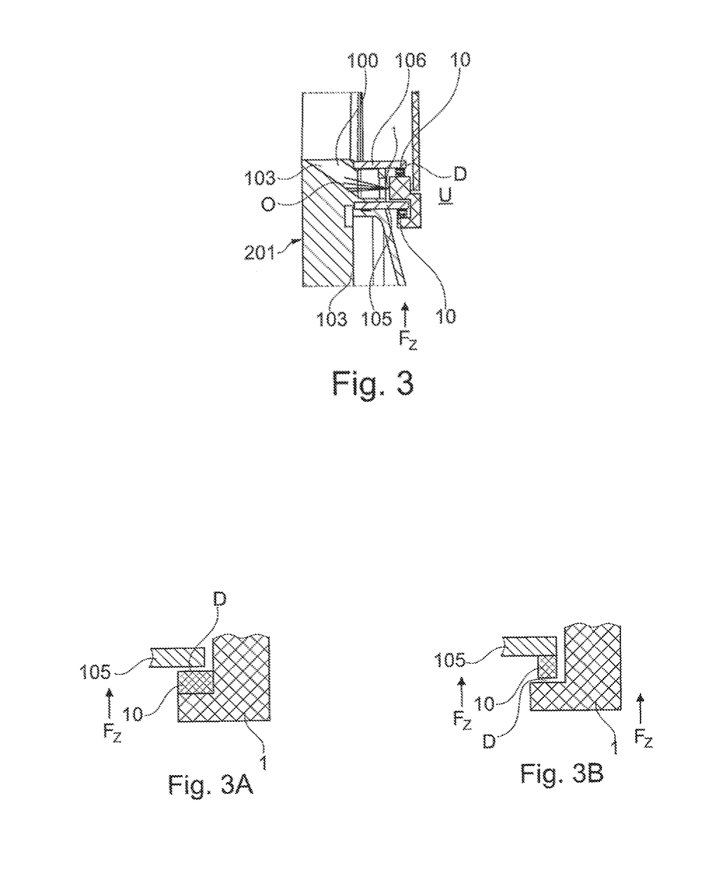

FIG. 3 shows a first embodiment of an oil distribution system having a contact seal that permits pressure equalization under the effect of a centrifugal force,

FIG. 3A shows a detail of the sealing gap of the embodiment in accordance with FIG. 3,

FIG. 3B shows a detail of an alternative embodiment to FIG. 3A,

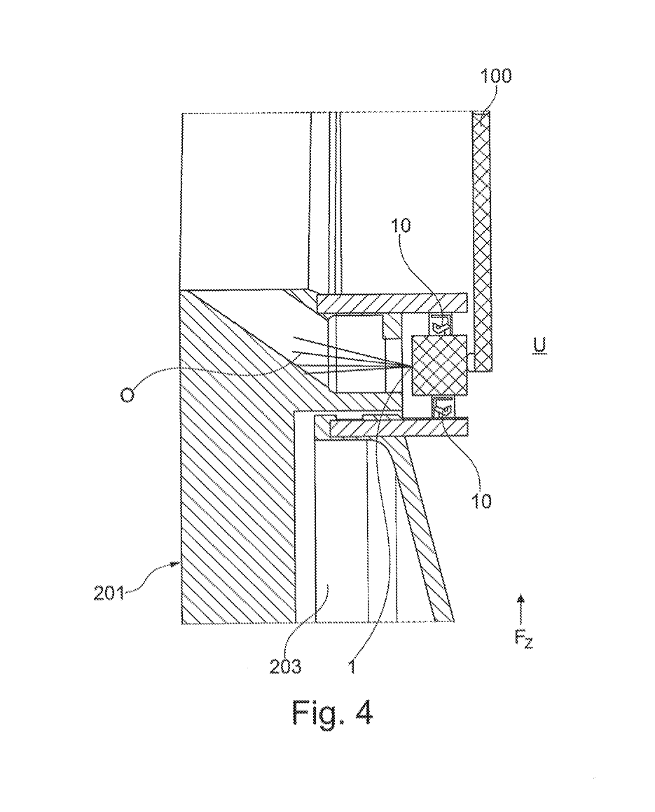

FIG. 4 shows a second embodiment of an oil distribution system having a contact seal that permits pressure equalization under the effect of a centrifugal force,

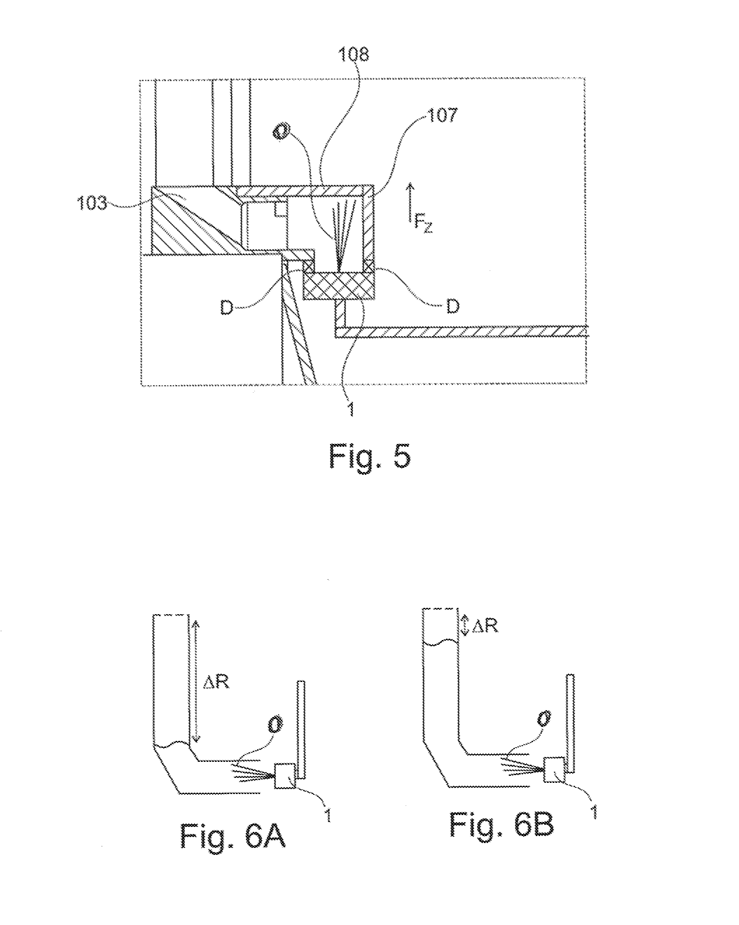

FIG. 5 shows a further embodiment of an oil distribution system having a contact seal that permits pressure equalization under the effect of a centrifugal force,

FIGS. 6A, B show a schematic representation of the setting of the oil level.

Before a detailed explanation of embodiments of the oil distribution system is made, firstly an aircraft engine 200 known per se in turbofan design with oil-consuming components, in this case a power gearbox 201 and a ball bearing 101 (see FIG. 2) of a shaft bearing 300, is shown as an example in connection with FIG. 1.

The aircraft engine 200 has here a rotational axis 210. Viewed in the main flow direction, the aircraft engine 200 has an air inlet 220, a fan stage 230, which can here be regarded as part of a low-pressure compressor 240 located behind it, a high-pressure compressor 250, a combustion chamber 260, a high-pressure turbine 270, a low-pressure turbine 280 and an outlet nozzle 290. A nacelle 291 surrounds the interior of the aircraft engine 200 and defines the air inlet 220.

The aircraft engine 200 operates in a manner known per se, where the air entering the air inlet 210 is accelerated by the fan stage 230, with two airflows being generated. A first airflow passes into the low-pressure compressor 240 inside a core engine 292. This airflow is then further compressed by the high-pressure compressor 250 and routed into the combustion chamber 260 for combustion. The resultant hot combustion gases are relieved in the high-pressure turbine 270 and the low-pressure turbine 280, with said gases driving the fan stage 230, the low-pressure compressor 240 and the high-pressure compressor 250 via a corresponding shaft system and finally exiting through the outlet nozzle 290.

A second airflow flows through a bypass duct 293 to generate most of the thrust.

With the turbofan design, the speed of the drive of the fan stage 230 is decoupled by the power gearbox 201 from the low-pressure turbine 280 providing the drive. The power gearbox 201 is a reduction gear using which the speed of the fan stage 230 is reduced relative to the speed of the low-pressure turbine 280. This allows the low-pressure turbine 280 to be operated more efficiently at higher speeds. The fan stage 230 can thus provide a higher thrust.

The power gearbox 201 can be designed as an epicyclic gearbox, here for example as a planetary gearbox, that has a considerable requirement for oil O and is surrounded by a casing 100. FIG. 1 shows schematically a sun gear 202 and planetary gears 203 of the power gearbox 201.

A further component that must be supplied with oil O is a ball bearing 101 in a shaft bearing 300 with a casing 100 (see FIG. 2).

In other embodiments, not shown here, the aircraft engine 200 can have a different design, e.g. with a different number of shafts being used. Also, it is not essential for the aircraft engine 200 to be of the turbofan type.

The oil supply to a ball bearing 101 inside a shaft bearing 300 with an oil supply system known per se is shown in FIG. 2, where for reasons of greater clarity the bearing casing 100 is not shown. Inside the shaft bearing, a ball bearing 101 is the component to be supplied with oil O.

The oil O is here sprayed in the axial direction from a distribution device 1, in this case a nozzle, into a collecting device 102. In alternative embodiments, the oil can also be sprayed in the radial direction (see FIG. 5) or at an angle (i.e. tangentially or at an angle between the radial and axial directions).

FIG. 2 shows only one distribution device. Further distribution devices are arranged in the circumferential direction at defined intervals. In alternative embodiments, apertures or other spraying means can also be used as the distribution device 1.

The collecting device 102 is in this case a kind of circumferential groove and rotating groove. Due to the rotation, the centrifugal force FZ acts on the oil, ensuring that the oil O is forced radially outwards (i.e. upwards in FIG. 2). The oil O is here on the one hand forced directly into the ball bearing 101. On the other hand, the oil O is conveyed by distribution devices 103, in this case a duct, to other components that also have to be supplied with oil O.

With an application of this type, a self-adjusting oil supply can be used that affords general advantages.

Inside the rotating collecting device 102 and the possibly following supply lines 103, a supply pressure is built up—as described—due to the centrifugal force FZ.

A system not sealed off from the environment U—as shown in FIG. 2—permits the option of having different liquid levels inside the rotating system. The supply pressure of the component 101 to be supplied with oil in the rotating system is dependent on the liquid level ΔR in FIGS. 6A (high level corresponding to high pressure) and 6B (low level corresponding to low pressure). The oil supply, i.e. the oil quantity sprayed-in, is as a rule constant or assumes a predetermined value.

If the counter-pressure, i.e. the prevailing pressure in the oil consumer and the pressure loss as far as the consumer, is within an acceptable range, adjustment is possible by the liquid level in the rotating supply lines.

With a rising oil volume flow (i.e. rising consumption), the supply pressure rises and more oil is forced into the bearing; the level falls (see FIG. 6B).

Conversely, the supply pressure falls as the volume flow falls, and the oil system is prevented from running empty by a suitably set counter-pressure, so that a reduced but continuous oil supply is achieved.

A system like this has however the limitation that the supply depends on centrifugal force and hence on speed. An oil supply to the consumers under pressure at standstill is thus impossible.

FIGS. 3 and 4 schematically show embodiments of oil distribution systems in connection with a power gearbox 201. The sections illustrated each show an oil supply for a planetary gearbox.

The single-hatched components in FIG. 3 and FIG. 4 are rotating components. The cross-hatched components in FIG. 3 and FIG. 4 are components that are stationary relative to the rotating components.

For sealing off the interior of the casing 100 from the environment, contact seals 10 are used here in each case, whose sealing effect is however only effective below a certain speed or at standstill. Hence, an unwelcome leakage of oil O during standstill is not possible.

Generally speaking, other seals, in particular labyrinth seals, can be used in this and also in other embodiments.

The pressure of the oil O adjusts during a rotation (e.g. between 50 and 1000 rpm) due to a balance between the centrifugal force acting on the oil O and the static pressure of the liquid column of the oil O (density approx. 950 kg/m3) under the counteracting force of gravity.

With a sufficiently high rotation, i.e. a sufficiently high centrifugal force FZ, the oil supply systems have a self-adjusting effect, as described in connection with FIGS. 2, 6a, 6b.

To do so, at least one contact seal 10 is used for sealing off the casing 100 from the environment U, and is designed and/or arranged in the oil distribution system such that during operation it creates a connection between the interior of the casing 100 and the environment U for pressure equalization due to the centrifugal force FZ.

FIGS. 3 and 4 each show an oil supply system in which a distribution device 1 sprays in oil in the axial direction (i.e. to the left in FIGS. 3 and 4). The oil O is supplied via a distribution device 103 into the interior of the casing 100 and hence into the power gearbox 201.

The distribution device 1 is arranged here in each case in a circumferentially arranged rotating surrounding element 105, 106, so that oil injection is screened off radially on the inside and outside. These surrounding elements 105, 106 are annular elements extending in the axial direction.

In FIG. 3, a contact seal 10 in the form of a radial shaft seal is arranged on the casing of the distribution device 1 opposite the radially inner surrounding element 105. The casing of the distribution device 1 is stationary relative to the contact seal 10. In the stationary state (e.g. at standstill), the contact seal 10 is in contact with the inner surrounding element 105, as shown in FIG. 3. During rotation, the inner surrounding element 105 is moved outwards due to the centrifugal force FZ, while the contact seal 10 is stationary. Due to the radial movement of the inner surrounding element 105 relative to the contact seal 10, a sealing gap D is released, permitting pressure equalization between the environment U and the interior of the casing 100.

It is thus possible during operation (i.e. in rotation) to have a self-adjusting oil supply again.

In a similar way, a contact seal 10 is arranged on the outer side of the casing of the distribution device 1 and in the stationary state (i.e. without rotation) presses in a sealing manner against the inside of the radially outer surrounding element 106.

In rotation, the radially outer surrounding element 106 is pulled outwards by the centrifugal force FZ and thus selectively releases a gap for pressure equalization between the environment U and the interior of the casing 100. The sealing gap D of the contact seal 10 opens under rotation.

FIG. 3A shows in detail the contact seal 10 for the radially inner surrounding element 105, i.e. for the event that the centrifugal force FZ pulls the rotating surrounding element 105 outwards. This opens the sealing gap D. A similar situation results at the contact seal 10 for the radially outer surrounding element 106.

FIG. 3B shows a variation of the embodiment according to FIG. 3A. Here too, the surrounding element 105 is pulled outwards due to the centrifugal force FZ. However, the contact seal 10 is arranged not on the distribution device 1, but on the rotating surrounding element 105.

FIG. 4 shows an embodiment in which the arrangement of the stationary and rotating parts is of somewhat different design. Both surrounding elements 105, 106 are designed rotating. One of the contact seals 10 is arranged on the radially outer surrounding element 106, such that under the effect of the centrifugal force FZ it lifts off from the casing of the distribution device 1 and releases the sealing gap D. The other contact seal 10 is arranged on the non-rotating casing of the distribution device 1, such that at this point there is no opening of the sealing gap D during rotation.

The embodiments according to FIGS. 3 and 4 therefore each feature a combination of a dynamic oil seal and a contact seal.

In an alternative embodiment, it is also possible to use only one contact seal 10, which is arranged such that the sealing gap D is opened during rotation. In the exemplary embodiments according to FIGS. 3, 3A and 4, the contact seal 10 does not rotate. It is in principle also possible for the contact seal 10 to co-rotate (see FIG. 3B), e.g. it is arranged on the respective outer part such that the seal is lifted off its sealing surface due to the centrifugal force FZ.

FIG. 5 shows an alternative embodiment in which—unlike in the embodiments of FIGS. 3 and 4—the oil O is sprayed out of the distribution device 1 in the radial direction. Rotating surrounding elements 107, 108 are used here to retain the oil O such that it can be guided in the direction of the distribution device 103. The surrounding elements 107, 108 are arranged here at an angle of 90° and are also used for deflecting the oil O, which is sprayed here in the radial direction. To do so, one surrounding element 107 is arranged in the radial direction, the other surrounding element 108 in the axial direction.

The previous embodiments related to the oil supply of a gearbox. Alternatively, embodiments of the oil distribution system can also be used for the supply of bearings.

### LIST OF REFERENCE NUMERALS

1 Distribution device, nozzle
10 Seal, contact seal
100 Casing
101 Component to be supplied with oil
102 Collecting device for oil
103 Distribution device for oil
104 Guiding surface, impingement surface
105 Radially inner surrounding element of distribution device
106 Radially outer surrounding element of distribution device
107 Axially aligned surrounding element of distribution device
108 Radially aligned surrounding element of distribution device
200 Aircraft engine
201 Power gearbox
202 Sun gear
203 Planetary gear
210 Rotational axis
220 Air inlet
230 Fan stage
240 Low-pressure compressor
250 High-pressure compressor
260 Combustion chamber
270 High-pressure turbine
280 Low-pressure turbine
290 Outlet nozzle
291 Nacelle
292 Core engine
293 Bypass duct
300 Shaft bearing
D Sealing gap
F_{z} Centrifugal force
Oil
U Environment

What is claimed is:

1. Oil distribution system for a casing having at least one component to be supplied with oil in the interior of the casing, where the oil can be fed into the interior of the casing by at least one distribution device and where during operation the oil is conveyed by a centrifugal force to the at least one component, wherein, at least one seal, in particular a contact seal or labyrinth seal for sealing off the casing from the environment, with the at least one seal being designed and/or arranged in the oil distribution system such that during operation it releases, due to the centrifugal force, at least one sealing gap for pressure equalization to provide a connection between the interior of the casing and the environment.

2. The oil distribution system according to claim 1, wherein the at least one component to be supplied with oil is a bearing, a plain bearing, a rolling bearing, a gear and/or an oil seal.

3. The oil distribution system according to claim 1, wherein the at least one seal is arranged on a non-rotating component and the sealing gap is formed towards a rotating component.

4. The oil distribution system according to claim 1, wherein the at least one seal is arranged on a rotating component and the sealing gap is formed towards a non-rotating component.

5. The oil distribution system according to claim 1, wherein the distribution device for oil is surrounded radially on the inside and/or the outside by a circumferentially arranged surrounding element and forms the sealing gap in each case in interaction with the at least one seal.

6. The oil distribution system according to claim 1, wherein the at least one distribution device for the oil has a nozzle or an opening.

7. The oil distribution system according to claim 1, wherein the distribution device sprays oil in the axial, in the radial, in an inclined direction between the axial and radial directions or in the tangential direction.

8. The oil distribution system according to claim 1, wherein the oil is conveyed via a collecting device, in particular a groove and/or a distribution device, to the at least one component to be supplied with oil.

9. The oil distribution system according to claim 1, wherein the casing is a gearbox casing, in particular for an epicyclic gearbox, a planetary gearbox, a power gearbox for a turbofan engine or a bearing casing.

10. The oil distribution system according to claim 1, wherein the at least one seal is designed as a radial seal or radial shaft seal.

11. The oil distribution system according to claim 1, wherein a self-adjusting oil supply of at least one component to be supplied with oil.

12. An aircraft engine, in particular a turbofan engine, having an oil supply system in accordance with claim 1.
